(19) United States
(12) Patent Application Publication
(10) Pub. No.: US 2005/0188400 A1
(43) Pub. Date: Aug. 25, 2005

(54) Process for modification of Ad content by localization

(76) Inventor: Drew Topel, Burlingame, CA (US)

Correspondence Address: BURNS DOANE SWECKER & MATHIS L L P, POST OFFICE BOX 1404, ALEXANDRIA, VA, 22313-1404, US

(21) Appl. No.: 11/111,250

(22) Filed: Apr. 20, 2005

Related U.S. Application Data
(63) Continuation-in-part of application No. 10/230,843, filed on Aug. 28, 2002, now abandoned.
(60) Provisional application No. 60/316,891, filed on Aug. 31, 2001.

(51) Int. Cl. H04N 7/16; H04N 7/10; H04N 7/025; H04N 5/445; G06F 3/00

(52) U.S. Cl. 725/36; 725/34; 725/35; 725/138; 725/42

(57) ABSTRACT

A process for modification of ad content to be displayed in a particular geographic location is “localized” to include content modified to fit the particular locale. Remote Ad Players are linked through wired or wireless connections or networks (LAN, MAN or WAN) to a central Ad Server that knows the location of each such device. A plurality of ad packages created as a combination of digital files are stored in a database associated with the Ad Server. Each ad package is comprised of an ad formed by a plurality of component parts, a list of the components, a plurality of localization components, a localization table, and a control file. The localization components include location specific modifications of at least some of the ad components of each ad. The localization table associates a plurality of the localization components with particular ad components. Since the Ad Server knows the location of each Ad player, it can localize an ad package before it is sent to a particular Ad Player, or alternatively, the Ad Server can send the entire ad package to the remote Ad Player and allow the Ad Player to use the control file to perform the localization function as it assembles the ad.

### RELATED APPLICATIONS

This application is a continuation-in-part of U.S. patent application Ser. No. 10/230,843 filed Aug. 28, 2002 entitled Automatic Modification of Ad Content by Localization which claims the benefit of U.S. Provisional Application No. 60/316,891, filed Aug. 31, 2001, and entitled Automatic Modification of Ad Content by Localization, the entire content of such applications being expressly incorporated herein by reference.

### FIELD OF THE INVENTION

The present invention relates generally to network based advertising and the control of remote displays, and more particularly to a method and process by which generic audio/visual ad content can be localized (modified) either remotely or on-site such that component parts of the ad are tailored to better fit the display environment or reflect various attributes or characteristics of the locale of the ad player, the intended audience or the time of play, etc.

### BACKGROUND OF THE INVENTION

The present invention utilizes what is now a common system for delivering advertising (ad content), including audio, still frame and/or full motion advertisements, to one or more electronic display devices. As generally depicted in FIG. 1 of the drawing, such systems typically include a central Ad Server and associated Database, and a plurality of display systems linked together by a network that may comprise, for example, a cable network, a wide area network (WAN), a municipal area network (MAN), a local area network (LAN), the Internet; an Intranet, or any combination of the above. Data is transmitted from the Ad Server over the network via a carrier such as cable, fiber optic lines, telephone lines, wireless connections, and so on, to various display systems and devices which may be located as close as next door, or as remote as thousands of miles away. Actual networks can be arranged in a variety of configurations; however, the example shown here is to provide a simplified framework for aiding the reader in understanding the type of environment in which the present invention operates.

The network environment relevant to the present invention usually includes a plurality of Ad Players that are connected to an Ad Server by way of a communications network. The Ad Players and Ad Server are connected to the communications network by way of appropriate communication interfaces well know in the art and which may also include a LAN, MAN or WAN. Such networking environments are commonplace in enterprise-wide computer networks, Intranets and the Internet.

The Ad Server provides for management of software services that are accessible to the Ad Player via the communications network. The software services provided may be, for example, accessible by way of Internet Protocol by addressing the Ad Server via a Universal Resources Locator (URL). For example, if the Ad Server were to be located at a particular Internet address, and the Ad Players located at other Internet addresses, then the several systems would be mutually accessible using a conventional browser, such as Microsoft Explorer, at their respective URLs. Moreover, although the Ad Server is depicted in FIG. 1 as a single unit, it will be appreciated that such a depiction is for illustrative purposes only. An actual implementation may consist of many servers either co-located or geographically dispersed, such as by distributing the functions, using mirror sites, and so on.

As part of its function as a server, the Ad Server may provide access to or maintain information. Typically, server computers maintain information in databases, such as that illustrated, by way of database server system software. The Ad Server might, for example, run the Microsoft Windows NT 4.0 operating system and Microsoft SQL Server 7.0 database management software.

In the example shown in FIG. 1, the Ad Server might provide services relating to the transmission to and control of display programming content on display devices, such as those shown. As such, an Ad Player which is associated with a particular display device, desiring to display programming on its associated display device, might access the Ad Server over the communications network to obtain computing services, upload or download programming content, and so on. The Ad Server can accept the programming content to be displayed, or provide services to generate programming content, and communicate the programming content to the Ad Player, which would in turn render the programming content on its display device. The programming content can be sent as MPEG packets, HTML pages, XML, AVI video, FLASH video, and other protocols for distributing content over a communications network.

Although such prior art systems are quite useful in that they allow an advertiser to select those ads that, based on the known demographics of a region, will be most appropriate for an audience in a particular location, such systems do not allow modification of ads so that the same ad can be specifically tailored to fit particular characteristics of the venue in which it is to be displayed. There is thus a need for a system and method by which ad content can be modified as appropriate to better suit a particular local environment or venue.

### SUMMARY OF THE INVENTION

It is therefore a principal objective of the present invention to provide a method or process of enabling advertisements or other programming to be localized so that they are more compatible with the local characteristics of the area and or audience.

Another objective of the present invention to provide a method or process whereby various attributes of an advertisement or other programming can be changed to more nearly comport with the ethnicity of the local audience.

Still another objective of the present invention to provide a method or process that permits the various constituent parts of an advertisement or other programming to be selected and assembled in a way that will be more attractive to a local audience.

Briefly, a presently preferred embodiment of the present invention includes a process whereby an advertisement or other programming selected for display in a particular geographic location can be “localized” to include content that has been modified to fit the particular locale. The advertisement or other programming in such case is usually one that has been made to be displayed on a device that shows dynamic content. Typically, this means that the ad or other programming is an electronically encoded graphic, and perhaps includes an audio file, and has been designed to be shown on a device such as a computer monitor or plasma display device driven by an Ad Player. The Ad Player, if remotely located, must also be linked through a suitable wired or wireless connection or a communication network (LAN, MAN or WAN) to a central Ad Server that knows the location of each such device through its database of display locations. In accordance with an exemplary embodiment of the present invention, a plurality of ads are created as a combination of digital files that are stored in a database associated with the Ad Server. Each ad includes a control file and a plurality of component parts identified by a list of component parts, and for at least some of the component parts, a plurality of localizing components and an accompanying localization table is provided that identifies location specific modifications that can be made to at least some of the component parts of the ad. Thus, since the Ad Server knows the geographic location of each Ad player to which it is connected, it can localize an ad before it is sent to a particular Ad Player, or alternatively, the Ad Server can simply send the ad package including the appropriate component files etc., to the remote Ad Player and allow the Ad Player to perform the localization function as it assembles the ad.

An important advantage of the present invention is that allows an advertisement or other programming to be simultaneously run in a plurality of culturally diverse venues, with each instantiation being appropriately configured, or “localized”, for the location in which it is displayed and/or performed.

Another advantage of the present invention is that the same ad can be run in the one location at a different time of day and be modified to suit the tastes, ethnicity or lifestyle of the viewing audience.

Still another advantage of the present invention is that it allows an ad or other programming to be continuously updated to follow changes in local audience makeup or environmental conditions.

These and other objects and advantages of the present invention will no doubt become apparent to those skilled in the art after having read the following detailed disclosure of an embodiment of the present invention schematically depicted in the several figures of the drawing.

### BRIEF DESCRIPTION OF THE DRAWING FIGURES

FIG. 1 is a block diagram schematically illustrating an overall system environment in which the invention may be practiced;

FIG. 2 is a block diagram schematically illustrating the data content processed by an Ad Server used in accordance with the present invention;

FIG. 3 is a simplified block diagram schematically illustrating the interactive relationship between the Ad Server and an Ad Player when operating in accordance with the present invention; and

FIG. 4 is a flow chart generally illustrating the program flow of a process in accordance with an embodiment of the present invention.

### DETAILED DESCRIPTION OF THE INVENTION

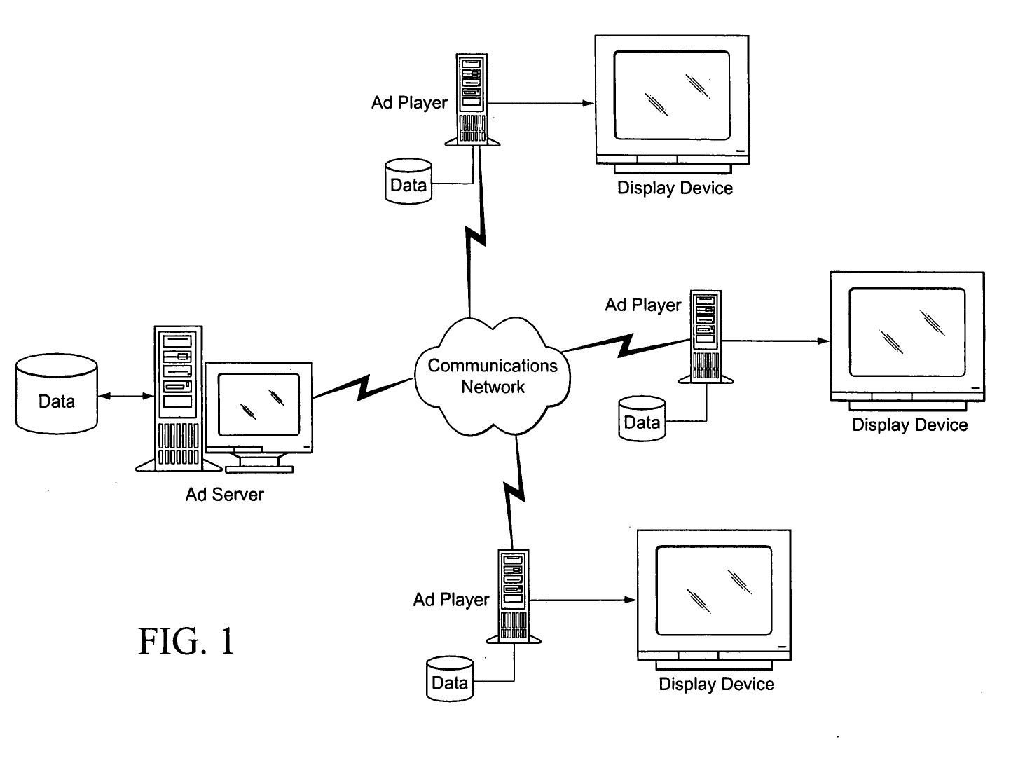

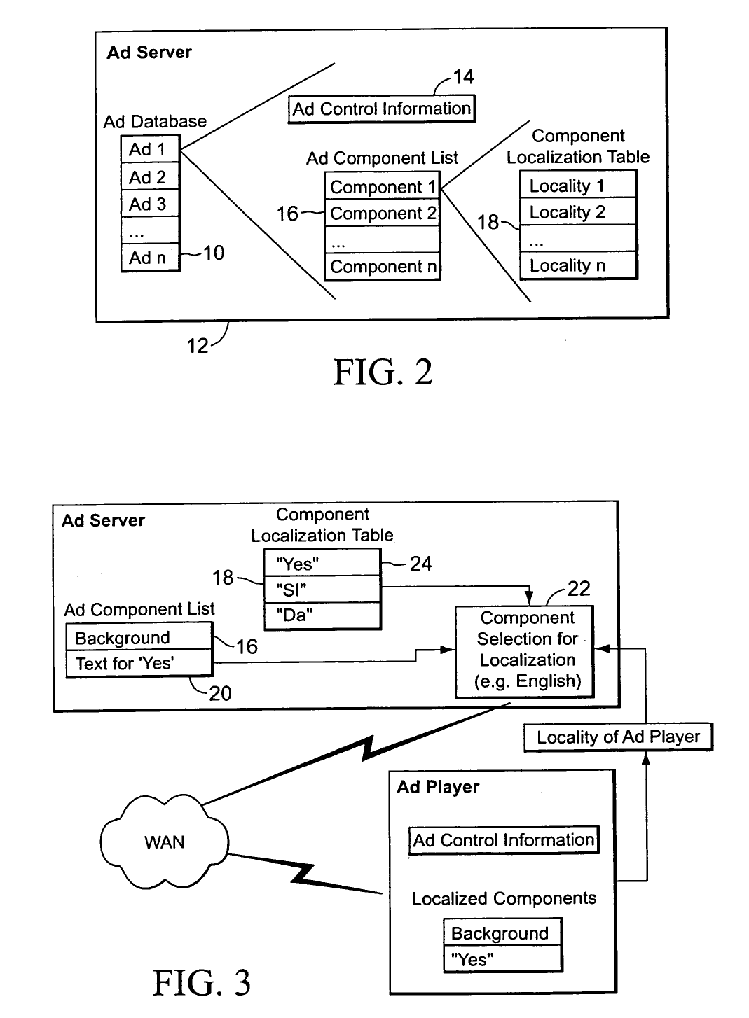

Referring now to FIG. 2 of the drawing, there is shown a series of tables that identify ad packages 1 -n and their constituent parts stored in the Ad Database 10 of an Ad Server 12. In addition to the ad components per se that when assembled make up the advertisement or other content to be displayed, these ad packages also include additional data used to facilitate localization and display on the various Display Devices making up a display network such as that depicted in FIG. 1. As depicted, each ad package in the Ad Server Database also includes a control file 14 that contains the master instruction set for driving a remote Ad Player and indicates how the ad components are to be assembled at runtime. Each ad package further includes an ad component list 16 that identifies each component of the corresponding ad.

For each component found in the ad component list, there is a component localization table 18 that contains ‘customizations’, i.e., modified substitute component parts, for at least some of the ad components, corresponding in some way to each locality in which the ad is to be played. The customizations include a wide variety of alternatives for the localizable components. For example, if the component is a background color, many alternative choices of colored backgrounds may be available; if the component includes people of a particular ethic background(s), localization components including people having different ethnic features may be selectable; similarly, localization components having different background settings may be selected; and, if the component is an audio component, statements in several languages, or different types of background music or ambient sounds may be available for selection to localize the ad. Basically, any ad component can be localized to reflect any appropriate attribute or characteristic of the locale in which the Ad Player is located.

In FIG. 3, the process of localization is illustrated in simplified form as is automated in the Ad Server. Each ad element, or component, in the ad component list must be sent to the Ad Player along with the Ad Control Information. But each component has the potential to be localized via the component localization table that is associated with each such component. The localization can be accomplished at the Ad Server or, after transmission, at the receiving Ad Player. In this example, the “Text for ‘Yes’” component 20 is illustrated as localizable. In accordance with the present invention, the Component Selection process for Localization 22 operator determines the locality of the particular Ad Player, finds that the audience is English speaking, looks to the Component Localization Table 18 for the English word for “yes”, and appropriately substitutes the element 24 for the component 20 to be localized.

In this example note that the localization criteria for an ad is English. So the English word ‘Yes’ is selected out of the possible localization component choices and sent along with the ad's other components and control information to the remote Ad Player. Thus, the table of ad components sent to the player contains components that have been localized for that Ad Player.

Given that any component can be customized for a particular locality, it is up to the producer of the ad to identify the components that need to be changeable to allow localization for the ad. He then creates each localization component and stores them in the Component Localization Table 18 so that the selection process can find the right localization component for delivery to a particular Ad Payer.

As another example, if the ad is to be played in a Spanish-speaking neighborhood, the ad would be changed to show all of its text, and play all of its audio in Spanish. The ad can also be customized in other ways to appeal to the backgrounds of the people to which it is targeted. For example, if the ad is to be displayed in the city, it might feature people who are dressed in business attire, but if it is to be played in a more country or suburban setting, the models would wear more casual clothes, etc.

As an alternative, rather than transmitting localized ad packages to the remote Ad Players, it may be desirable in certain circumstances to transmit a complete ad package including the Component Localization Table for the ad in question to the remote Ad Player so that the localization function can be performed locally. This might be desirable, for instance, in a case where the desired attributes of a particular component might change over a period of time. As an example, if the venue is a resort airport and the incoming/outgoing flights at a particular dock at particular times of day carry passengers from geographically diverse regions of the world, it might be desirable that the advertisement be localized on a periodic basis to match the profiles of the viewers arriving or departing at the particular times in question. Conceivably, it might be more advantageous to perform the localization function locally at the Ad player rather than at the Ad Server.

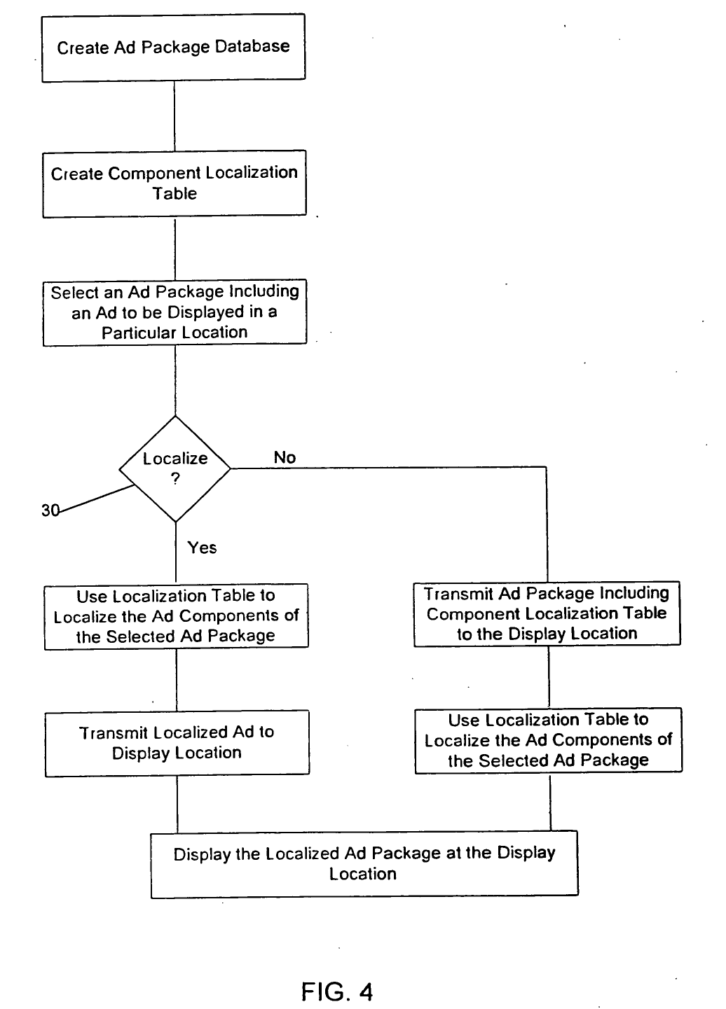

In conclusion, reference is made to the flow chart diagram of FIG. 4 wherein the principal operative steps of an embodiment of the present invention are set forth by way of example. As illustrated by the inclusion of the decision box 30, the invention can be practiced by performing the localization function at either the Ad Server or at the remote Ad Player. In either case, the result is that the ad content of the advertisement is enhanced. In this example, the first step is to create the ad packages to be stored in the system database. For instance, there might be 10 ads (or other display content) that are going to be displayed on the system's display screens during the next week. So 10 different packages including their component parts and control information are designed and stored in the system database. Then taking into consideration the locations in which the system's displays are dispersed, the localization components are generated and stored in the database along with localization tables for each ad component.

The system is now ready to begin its display operation. An ad to be displayed can be selected at either the Ad Server or at an Ad Player. In either case the Ad Server will at all times be aware of the locations of the several Ad Players, and thus can either perform the localizations or transfer all needed information to the Ad Players to enable them to perform the localizations. Thus, as suggested by the decision box 30, before an ad is sent to a player, a determination is made as to whether the ad is to be localized by the Ad Server or sent to the Ad Player for localization. If the Ad Server is to do the localization, it will use the localization table and send the localized ad and control file to the designated Ad Player. On the other hand, if the localization is to be done by the Ad Player, a complete ad package including ad components, control file, localization components and localization table will be sent to the Ad Player and it will use the control file to perform the localizing operation. In either case once the ad is localized it is ready for display, and the Ad Player can perform the display. Note that as suggested above, a single ad can be localized in several formats so as to address different audiences at different times.

Although the present invention has been described in terms of a preferred embodiment, it is anticipated that other alterations and modifications will become apparent to those skilled in the art after having read the above disclosure. It is therefore intended that such disclosure be considered illustrative and not limiting, and that the appended claims be interpreted to include all such embodiments, alterations and modifications as fall within the true spirit and scope of the invention.

1. A process for modification of ad content such that a particular ad will be localized by modification to reflect attributes, characteristics or environmental conditions associated with the location of a displaying ad player, comprising:
developing a plurality of ad packages relating to ads that can be stored in a database processed by an associated ad server, and selected for transmission to and display by ad players that are remote from but communicatively coupled to the ad server, each said ad package relating to a particular ad having content including a plurality of basic component parts that when assembled constitute said particular ad, each said ad package including said basic component parts, an ad component list identifying each said basic component part, and an ad control file containing an instruction set indicating how the basic component parts in said ad package are to be assembled at runtime to produce said particular ad;
developing, for at least some of said basic component parts of each said ad package, one or more localized component parts modified to reflect an attribute, characteristic or environmental condition associated with the location of each said ad player, and storing said localized component parts in said database;
developing a component localization table identifying the localized component parts to be substituted for the basic component parts of each said ad to be played by each said ad player, and storing said localization table in said database;
causing a particular ad player to communicate to the ad server the selection of a particular ad package for display by said particular ad player, said ad server being programmed to respond to the selection and to localize the selected ad package to include the appropriate localized component parts and to transmit the localized ad package to said particular ad player for display thereby, and
causing said particular ad player to use the ad control file in the localized ad package to assemble and display the localized ad.

2. A process for modification of ad content as recited in claim 1 wherein at least some of said localized component parts are varied to reflect different attributes or characteristics associated with different viewer profiles expected to view the ad at various particular times, and wherein said ad player is caused to select and assemble said various localized component parts and to display corresponding differently localized ads at said particular times.

3. A process for modification of ad content as recited in claim 1 and further comprising causing said ad player to communicate to the ad server the selection of an ad package to be localized on a periodic basis to match differing environments at different times in the local of said ad player, and wherein in response thereto said ad server correspondently localizes the selected ad to match said different environments and transmits different localized ad packages to said ad player for timely display thereby.

4. A process for localizing ad content in ad packages stored in a database and transmitted by an ad server via a communications network to ad players remotely located relative to the ad server, comprising the steps of:
creating for storage in an electronic database a plurality of location independent ad packages, each of which is comprised of a plurality of ad components forming the content of the ad in that ad package, an ad component list identifying the components forming the content of the ad in that ad package, and an ad control file containing an instruction set indicating how the ad components in that package are to be assembled at runtime;
creating, for at least some of the ad components in each said ad package, a plurality of localizing ad components having attributes or characteristics corresponding to particular environment or geographic locations associated with various remotely located ad players; and a component localization table identifying said localizing ad components, all of which are added to each said ad package;
causing a particular ad player to communicate to the ad server the selection of a particular ad package for localization and display by said particular ad player,
causing said ad server to respond to the selection by transmitting the requested ad package including its ad control file, its ad components and localizing ad components, and its localizing ad components list and component localization table to said particular ad player;
causing said particular ad player to receive the requested ad package and to use said ad control file to assemble a localized ad by selecting for inclusion therein the localizing ad components corresponding to said particular ad player; and
causing said ad player to display the localized ad.

5. A process for modification of ad content as recited in claim 4 and further comprising causing said particular ad player to select time related environmentally distinguished localizing ad components to localize the selected ad to match differing environments at different times in the locale of said particular ad player.

6. A process for modification of ad content as recited in claim 4 and further comprising causing said ad player to localize the selected ad on a periodic basis to match different profiles of different viewers at different times.

7. A process for modification of ad content for display on an electronic display unit at a particular location, comprising the steps of:
creating an ad server controlled electronic database of ad packages, each of which is comprised of a plurality of ad components forming the content of the ad in that ad package, an ad component list identifying the components forming the content of the ad in that ad package, and an ad control file containing an instruction set indicating how the ad components in that package are to be assembled at runtime;
creating, for at least some of the ad components in said ad packages, a plurality of localizing ad components having attributes or characteristics corresponding to particular environmental conditions or geographic locations associated with a particular remotely located ad player; and a component localization table identifying said localizing ad components, said localizing ad components and said component localization tables being added to corresponding ones of said ad packages;
selecting a particular ad package from the database including an ad to be displayed by a particular ad player in a particular location;
determining whether the selected ad package is to be localized prior to or after transmission to said particular ad player;
if said selected ad package is to be localized prior to transmission, then
causing said ad player to communicate its selection of a specific ad package and localizing instruction to said ad server, said ad server being programmed to respond to the selection and localizing instruction, and to localize the selected ad package to include the localization components corresponding to said particular ad player, and to transmit the localized ad package to said particular ad player for display thereby; or
if said selected ad package is to be localized by said particular ad player, then
causing said particular ad player to communicate to the ad server its selection and request for transmission of a specific ad package, said ad server being programmed to respond by transmitting the requested ad package to said particular ad player, said particular ad player being programmed to receive the requested ad package and to use the included ad control file to develop a localized ad by selecting, for inclusion therein, the localizing components identified by the component localization table corresponding to said particular ad player; and
causing said particular ad player to display the localized ad.

8. A process for modification of ad content as recited in claim 7 wherein the selected ad package is to be localized by said ad server, and further comprising causing said ad server to localize the selected ad on a periodic basis to match differing environments at different times in the locale of said ad player.

9. A process for modification of ad content as recited in claim 7 wherein the selected ad package is to be localized by said ad server, and further comprising causing said ad server to localize the selected ad on a periodic basis to match different profiles of different viewers at different times.

10. A process for modification of ad content as recited in claim 7 wherein the selected ad package is to be localized by said ad player, and further comprising causing said ad player to localize the selected ad on a periodic basis to match differing environments at different times in the locale of said ad player.
